(19) United States
(12) Patent Application Publication
(10) Pub. No.: US 2026/0254327 A1
(43) Pub. Date: Aug. 27, 2026

(54) MANUFACTURING A STATOR HAVING A MULTI-LAYER EXPANDING SLOT LINER

(71) Applicant: Atieva, Inc., Newark, CA (US)

(72) Inventors: Sahil Rahimi, Union City, CA (US); Brian Richard Ureste, Oakdale, CA (US); Vivek Meenakshi Sundaram, Newark, CA (US)

(21) Appl. No.: 19/060,278

(22) Filed: Feb. 21, 2025

(51) Int. Cl. H02K 15/108; H02K 3/487; H02K 15/062; H02K 15/121; H02K 15/40

(52) U.S. Cl. CPC H02K 15/108; H02K 3/487; H02K 15/062; H02K 15/121; H02K 15/40; H02K 2215/00

(57) ABSTRACT

A method comprises: placing a slot liner and a winding inside a slot of a stator core, the slot liner including i) a base layer of a dielectric material, and ii) an expanding material that comprises a first expanding material on a first side of the base layer and a second expanding material on a second side of the base layer opposite the first side; expanding the expanding material by applying first heat to the expanding material through the stator core, and by applying second heat to the expanding material through the winding; and curing the expanding material by applying third heat to the expanding material through the stator core, and by applying fourth heat to the expanding material through the winding.

### TECHNICAL FIELD

This document relates to manufacturing a stator having a multi-layer expanding slot liner.

### BACKGROUND

In recent years, the world's transportation has begun a transition away from powertrains primarily driven by fossil fuels and toward more sustainable energy sources. The majority of such increasingly prevalent powertrains include electric motors where a stator provides a rotating magnetic field that drives a rotor. Typically, the stator includes windings arranged in stator slots.

### SUMMARY

In a first aspect, a method comprises: placing a slot liner and a winding inside a slot of a stator core, the slot liner including i) a base layer of a dielectric material, and ii) an expanding material that comprises a first expanding material on a first side of the base layer and a second expanding material on a second side of the base layer opposite the first side; expanding the expanding material by applying first heat to the expanding material through the stator core, and by applying second heat to the expanding material through the winding; and curing the expanding material by applying third heat to the expanding material through the stator core, and by applying fourth heat to the expanding material through the winding.

Implementations can include any or all of the following features. At least one of applying the first heat or applying the third heat comprises using an induction heater to induce heat in the stator core. At least one of applying the first heat or applying the third heat comprises using at least one oven for heating the stator core. Heating the stator core comprises using a first oven for expanding the expanding material and using a second oven for curing the expanding material. At least one of applying the second heat or applying the fourth heat comprises performing Joule heating of the winding. The method comprises placing the slot liner and a plurality of windings inside the slot, the plurality of windings including the winding, the plurality of windings forming a stack inside the slot. Placing the slot liner and the plurality of windings inside the slot comprises causing only the first expanding material, and not the second expanding material, in part to abut the slot, and comprises causing only the second expanding material, and not the first expanding material, in part to abut the plurality of windings. Placing the slot liner and the plurality of windings inside the slot comprises wrapping the slot liner around an entire periphery of the stack, and wherein ends of the slot liner overlap each other at one end of the stack. The slot is an open slot having an opening, the method further comprising, after placing the slot liner and the plurality of windings inside the slot, covering the opening using a wedge. Placing the slot liner and the plurality of windings inside the slot comprises wrapping the slot liner around an entire periphery of the stack, and wherein ends of the slot liner overlap each other between two adjacent windings of the plurality of windings. The slot is an open slot having an opening, the method further comprising, after placing the slot liner and the plurality of windings inside the slot, covering the opening using a wedge. Placing the slot liner and the plurality of windings inside the slot comprises wrapping the slot liner around substantially an entire periphery of the stack without ends of the slot liner overlapping each other. The slot is an open slot having an opening, the method further comprising, after placing the slot liner and the plurality of windings inside the slot, covering the opening using a wedge. The slot is a closed slot. Placing the slot liner and the plurality of windings inside the slot comprises causing each of the first expanding material and the second expanding material in part to abut the slot, and comprises causing each of the first expanding material and the second expanding material in part to abut the plurality of windings. Placing the slot liner inside the slot comprises positioning the slot liner between two adjacent windings of the plurality of windings, and wrapping a remainder of the slot liner around an entire periphery of the stack. The slot is an open slot having an opening, the method further comprising, after placing the slot liner and the plurality of windings inside the slot, covering the opening using a wedge. The winding is a single winding of the slot. The slot is an open slot having an opening, wherein the slot liner is a first slot liner, wherein only the first expanding material of the first slot liner, and not the second expanding material of the first slot liner, in part abuts the slot, and wherein only the second expanding material of the first slot liner, and not the first expanding material of the first slot liner, in part abuts the winding, the method further comprising placing also a second slot liner inside the slot to cover a portion of a periphery of the winding not covered by the first slot liner. The periphery of the winding has a trapezoid shape.

In a second aspect, a system comprises: a controller configured for performing a heating process for a stator as defined by a time based profile, the stator including a stator core having a slot, a slot liner and a winding to be placed inside the slot, the slot liner including i) a base layer of a dielectric material, and ii) an expanding material that comprises a first expanding material on a first side of the base layer and a second expanding material on a second side of the base layer opposite the first side; a first heater operated by the controller, the first heater to apply first heat to the expanding material through the stator core to expand the expanding material, and to apply third heat to the expanding material through the stator core to cure the expanding material; and a second heater operated by the controller, the second heater to apply second heat to the expanding material through the winding to cure the expanding material, and configured to apply fourth heat to the expanding material through the winding to cure the expanding material.

Implementations can include any or all of the following features. The first heater comprises an induction heater including a coil, wherein the stator core is placed inside the coil for the induction heater to apply the first heat and the third heat. The second heater comprises one or more ovens, wherein the stator core is placed inside the one or more ovens for the second heater to apply the first heat and the third heat. The second heater comprises at least a first oven and a second oven, wherein the stator core is placed inside the first oven for the second heater to apply the first heat and wherein the stator core is placed inside the second oven for the second heater to apply the third heat.

### BRIEF DESCRIPTION OF DRAWINGS

FIG. 1 shows an example of a system that can be used for developing a time based profile for a multi-layer expanding slot liner to be installed in a stator.

FIG. 2 shows an example where expansion of expanding materials of a slot liner is performed.

FIG. 3 shows an example where the expanding materials of the slot liner of FIG. 2 have been expanded.

FIG. 4 shows an example where curing of the expanded materials of the slot liner of FIG. 3 is performed.

FIG. 5 shows an example where the expanded materials of the slot liner of FIG. 4 have been cured.

FIG. 6 shows an example of an open slot with a slot liner and windings.

FIG. 7 shows another example of an open slot with a slot liner and windings.

FIG. 8 shows another example of an open slot with a slot liner and windings.

FIG. 9 shows another example of an open slot with a slot liner and windings.

FIG. 10 shows another example of a closed slot with a slot liner and windings.

FIG. 11 shows another example of an open slot with a slot liner and a winding.

FIG. 12 schematically shows an example of performing expansion using an expansion oven and performing curing using a cure oven.

FIG. 13 shows an example of a system that can be used for performing heat treatment according to a time based profile when installing a multi-layer expanding slot liner in a stator.

Like reference symbols in the various drawings indicate like elements.

### DETAILED DESCRIPTION

This document describes examples of systems and techniques for manufacturing a stator having a multi-layer expanding slot liner. In some implementations, the expanding slot liner includes a base layer of a dielectric material, and layers of expanding materials on opposite sides of the base layer. While manufacturing the stator, the slot liner and one or more windings can be placed in a stator slot of a stator core so that one area of expanding material abuts the winding, and another area of expanding material abuts the surface of the stator slot. The areas of expanding material can be expanded and cured by applying heat according to a time based profile. Heat can be applied to the slot liner by heating the stator core, and heat can be applied to the slot liner by heating the winding.

As used herein, a vehicle is a machine that transports passengers or cargo, or both. A vehicle can have one or more electric motors. Examples of vehicles include, but are not limited to, cars, trucks, buses, motorcycles, and scooters. The number of wheels can differ between types of vehicles, and one or more (e.g., all) of the wheels can be used for propulsion of the vehicle. The vehicle can include a passenger compartment accommodating one or more persons. A vehicle can be powered exclusively by electricity, or can use one or more other energy source in addition to electricity, to name just a few examples.

As used herein, an electric motor can be any type of electric motor, including, but not limited to, a permanent-magnet motor, an induction motor, a synchronous motor, or a reluctance motor.

As used herein, a dielectric material of a slot liner includes any material with which the slot liner is electrically insulating. In some implementations, the dielectric material can include a polymer. For example, the polymer can include a polyester (e.g., poly(arylene ether nitrile) or polyethylene naphthalate). As another example, the polymer can include an aramid polymer (e.g., the NOMEX® material from DuPont). A dielectric material can be a single layer or can include a laminate.

As used herein, an expanding material of a slot liner includes any material that expands when heated and that cures in an expanded state in response to heat. In some implementations, the expanding material includes a polymer in which a blowing agent is introduced. In some implementations, the expanding material can be a composite. For example, the expanding material can include at least one of poly(ether ether ketone), (PEEK), diphenyl poly(ether ether ketone) (PEDEK), or poly(ether imide) (PEI). In some implementations, the expanding material includes an epoxy.

As used herein, a controller includes circuitry that can be programmed or otherwise caused to perform functions or other operations. A controller can be implemented in form of an integrated circuit (e.g., one or more chips).

Examples described herein refer to a top, bottom, front, or rear. These and similar expressions identify things or aspects in a relative way based on an express or arbitrary notion of perspective. That is, these terms are illustrative only, used for purposes of explanation, and do not necessarily indicate the only possible position, direction, and so on.

Generally, an electric motor can include a stator and rotor where the interaction of magnetic fields produced by each of these parts with appropriate currents results in torque at the rotor. The torque produced by the electric motor is directly related to the amount of current that can be passed through the winding. The magnet wire that is used to form the winding has a specified temperature rating (thermal index). The short duty torque production is defined by the amount of time that the current can be applied while keeping the winding below the specified temperature rating. In a highly power-dense motor, extracting heat from the winding is difficult. Effectively removing such heat increases the time at peak torque and/or the peak torque.

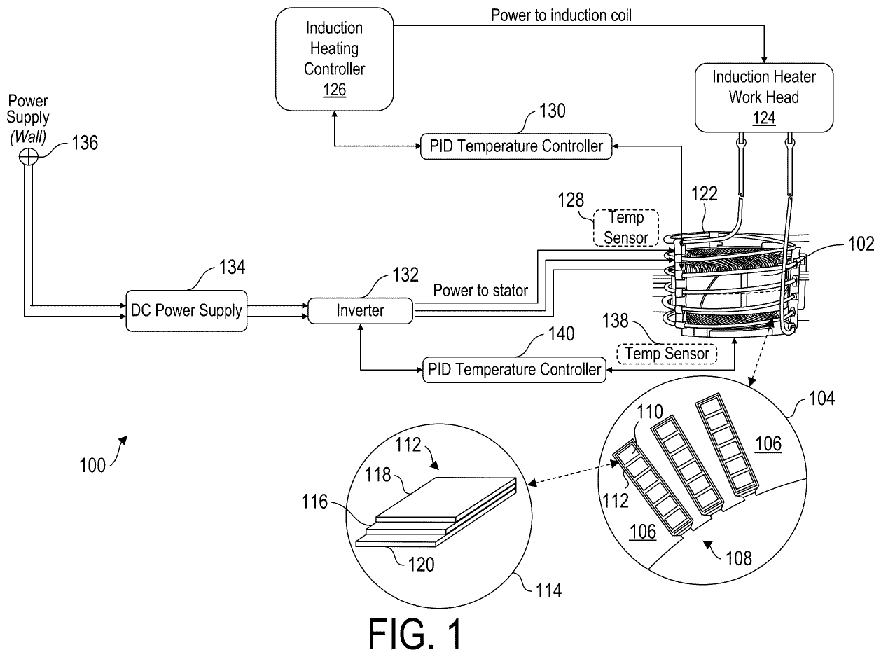

FIG. 1 shows an example of a system 100 that can be used for developing a time based profile for a multi-layer expanding slot liner to be installed in a stator 102. The system 100 can be used with one or more other examples described elsewhere herein. An enlargement 104 shows that the stator 102 includes a stator core 106 (e.g., formed by assembling respective laminations into a stack). Stator slots 108 are formed in the stator core 106. For example, each of the stator slots 108 is defined by respective openings in the laminations, and the openings are aligned with each other so the stator slots 108 extend parallel to the axis of the stator 102. One or more windings 110 is placed in each of the stator slots 108. A slot liner 112 is placed between the winding(s) 110 and the surface of the stator slot 108. The slot liner 112 provides dielectric insulation between the winding 110 and the stator core 106, and can also protect the winding 110 from damage while being inserted into the stator slot 108.

The slot liner 112 is a multi-layer expanding slot liner. An enlargement 114 shows a portion of the slot liner 112 separate from the winding 110 and the stator slot 108 for clarity. Particularly, the slot liner 112 includes a base layer 116 of a dielectric material, and also expanding material on both sides of the base layer 116. Here, the expanding material includes an expanding material 118 and an expanding material 120. The expanding material 118 is positioned on one side of the base layer 116, and the expanding material 120 is positioned on the opposite side of the base layer 116. When the slot liner 112 has been installed in the stator slot 108 (e.g., according to process examples described below), the main surface of the expanding material 118 can abut the surface of the stator slot 108, and the main surface of the expanding material 120 (hidden in the illustration) can abut the winding 110. Thus, the slot liner 112 can provide dielectric insulation between the winding 110 and the stator core 106 while allowing heat generated in the winding 110 to flow into the stator core 106 for cooling of the electric motor, and can protect the winding 110 (each of which can separately be covered in insulating material) while the winding 110 is being inserted into the stator slot 108. For example, at the end of the stator core 106 where the winding extends out of the stator slot 108, the slot liner 112 can extend a short distance beyond the end of the stator slot 108, so as to protect the winding 110 which often makes a sharp turn at this location.

As part of manufacturing the stator 102 the expanding material 118 and the expanding material 120 are to be heat treated to ensure that the slot liner 112 installed in the stator slot 108 is conditioned for its function. The heat treatment will include a stage during which the expanding material 118 and the expanding material 120 are expanded to a greater thickness, and also a stage during which the expanded instances of the expanding material 118 and the expanding material 120 are cured to ensure that they remain in their expanded states. The system 100 can be used for developing a time based profile for how to perform the heat treatment so that the expansion and the curing occur according to specified standards.

The system 100 can include one or more types of heaters to be used on the stator 102. Here, the system 100 includes an induction heater 122 to induce heat in the stator core 106 of the stator 102. The induced heat raises the temperature of the stator core 106, including at the surfaces of the stator slots 108 so that they apply heat to the slot liner 112. In some implementations, the induction heater 122 includes a coil in which the stator 102 is placed. The coil is powered by alternating current (AC) to create a rapidly fluctuating magnetic field that induces eddy currents in the stator core 106 to generate heat.

The system 100 can include an induction heater work head 124 that powers the induction heater 122 for inducing the heat. For example, the induction heater work head 124 is coupled to an AC power source. The system 100 can include an induction heating controller 126 that controls the heating performed by the induction heater 122. For example, the amount of induction produced and/or the duration of the heat induction can be controlled.

The system 100 can be a closed loop system. In some implementations, the system 100 is designed for supporting the creation of a heat treatment process that is to be used in producing stators having multi-layer expanding slot liners, and the feedback can help develop the operational parameters of the heat treatment process.

The system 100 can include one or more thermocouples for monitoring the temperature at or near the slot liner 112 for developing the heat treatment process. In some implementations, a temperature sensor 128 can be placed inside the stator 102 and coupled to a proportional-integral-derivative (PID) temperature controller 130 that is also in communication with the induction heating controller 126. The temperature sensor 128 is here shown separately from the stator 102 for clarity. For example, the temperature sensor 128 can be positioned between the expanding material 118 and the surface of the stator slot 108. As such, the temperature outputs by the temperature sensor 128 can be indicative of the amount of heating at the slot liner 112 as a result of the induced heating by the induction heater 122. The induction heating controller 126 can regulate the induction heating by the induction heater 122 based on the closed-loop feedback by the temperature controller 130.

The system 100 can include one or more types of heaters to be used on the winding 110. Here, the system 100 drives an inverter 132 using a direct current (DC) power supply 134 powered by an AC power supply 136 (e.g., an outlet providing grid power). The inverter 132 provides AC (e.g., having three phases) to the winding 110 of the stator 102. The current flowing through the winding 110 causes Joule heating in the winding 110, thus heating the slot liner 112,

In some implementations, a temperature sensor 138 can be placed inside the stator 102 and coupled to a PID temperature controller 130 that is also in communication with the inverter 132. The temperature sensor 138 is here shown separately from the stator 102 for clarity. For example, the temperature sensor 138 can be positioned between the expanding material 118 and the winding 110. As such, the temperature outputs by the temperature sensor 138 can be indicative of the amount of heating at the slot liner 112 as a result of the Joule heating by the winding 110. The inverter 132 can regulate the Joule heating of the winding 110 based on the closed-loop feedback by the temperature controller 140. Chokes can be added to minimize the noise in the signals from the temperature sensor temperature sensors 128 and 138.

The above examples illustrate that a method can include placing a slot liner (e.g., the slot liner 112) and a winding (e.g., the winding 110) inside a slot (e.g., the stator slot 108) of a stator core (e.g., the stator core 106), the slot liner including i) a base layer (e.g., the base layer 116) of a dielectric material, and ii) an expanding material that comprises a first expanding material (e.g., the expanding material 118) on a first side of the base layer and a second expanding material (e.g., the expanding material 120) on a second side of the base layer opposite the first side. The method can include expanding the expanding material by applying first heat to the expanding material through the stator core (e.g., using the induction heater 122), and by applying second heat to the expanding material through the winding (e.g., using the inverter 132). The method can include curing the expanding material by applying third heat to the expanding material through the stator core (e.g., using the induction heater 122), and by applying fourth heat to the expanding material through the winding (e.g., using the inverter 132).

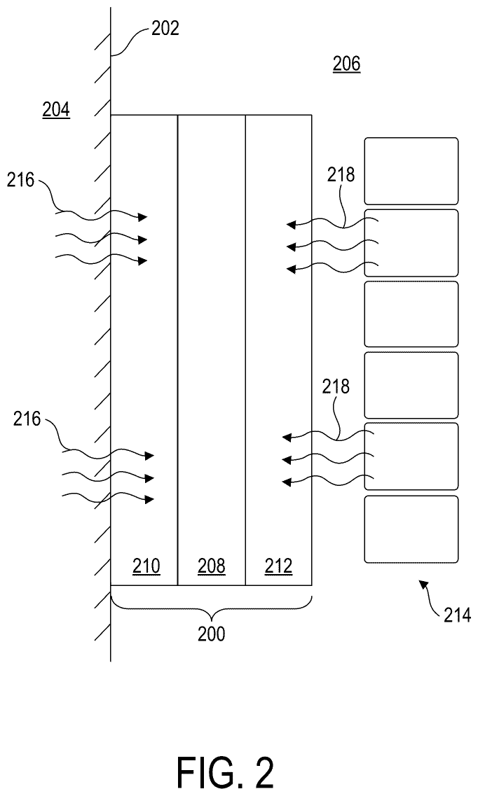

FIG. 2 shows an example where expansion of expanding materials of a slot liner 200 is performed. The examples described with regard to the slot liner 200 can be used with one or more other examples described elsewhere herein.

The present example shows the slot liner 200 at the beginning of performing heat treatment according to the present subject matter. The slot liner 200 is shown together with a surface 202 of a stator body 204 in which a stator slot 206 is formed. The stator body 204 and the stator slot 206 are only partially shown for clarity. The slot liner 200 is a multi-layer expanding slot liner. Here, the slot liner 200 includes a base layer 208 of a dielectric material, and also expanding material on both sides of the base layer 208. Here, the expanding material includes an expanding material 210 facing (e.g., abutting or adjacent) the surface 202, and an expanding material 212 facing (e.g., abutting or adjacent) a winding 214 positioned in the stator slot 206. The winding 214 can include one or more separate conductors. For example, when separate conductors are used each of them can be individually coated with an insulating layer.

As part of the heat treatment, heat 216 can be applied to the slot liner 200 through the stator body 204. The heat 216 can be generated by inductive heating or by radiant heat from an oven, to name just two examples. The heat 216 here enters the expanding material 210 and can cause the expanding material 210 to begin expanding. Also as part of the heat treatment, heat 218 can be applied to the slot liner 200 through the winding 214. The heat 218 can be generated by Joule heating, for example. The heat 218 here enters the expanding material 212 and can cause the expanding material 212 to begin expanding.

The heat treatment can involve applying the heat 216 and the heat 218 for the same amount of time as each other, or for different times. For example, the Joule heating which is more direct may be performed for a shorter time than core heating. The specifications regarding the slot liner 200 can define the amount and level of heating that should be performed for expansion of the expanding material 210 and the expanding material 212. For example, the specifications can give a temperature range for expansion.

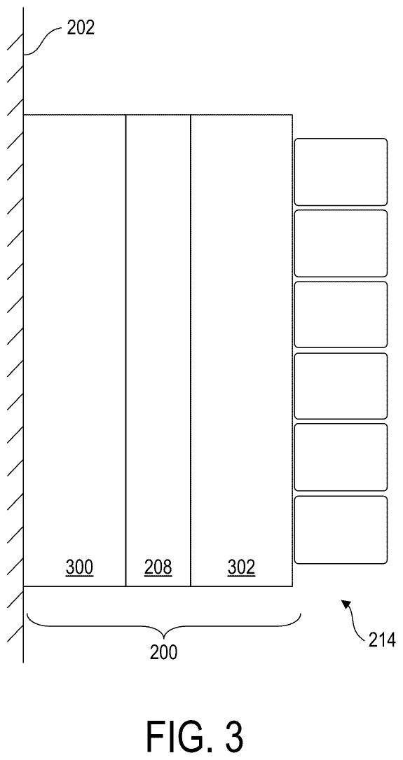

FIG. 3 shows an example where the expanding materials of the slot liner 200 of FIG. 2 have been expanded. For example, the expansion involves the creation of air bubbles inside the expanding materials. The slot liner 200 here has an expanded material 300 that abuts the surface 202, and an expanded material 302 that abuts the winding 214. The base layer 208, by contrast, may be essentially unaffected by the expansion heating. As such, the expanding materials of the slot liner 200 have been expanded so that the slot liner 200 substantially fills the gap between the winding 214 and the surface 202. For example, the integrity of the expanded material may be higher when the material has expanded into contact with another surface, here the surface 202 and the winding 214, as opposed to expanding just into air.

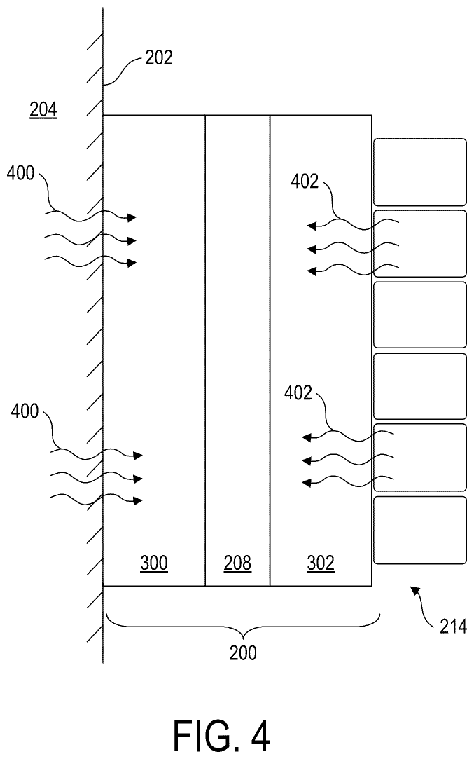

FIG. 4 shows an example where curing of the expanded materials of the slot liner 200 of FIG. 3 is performed. As part of the heat treatment, heat 400 can be applied to the expanded material 300 through the stator body 204. The heat 400 can be generated by inductive heating or by radiant heat from an oven, to name just two examples. The heat 400 here enters the expanded material 300 and can cause the expanding material 210 to begin curing. Also as part of the heat treatment, heat 402 can be applied to the expanded material 302 through the winding 214. The heat 402 can be generated by Joule heating, for example. The heat 402 here enters the heat 402 and can cause the heat 402 to begin curing.

The heat treatment can involve applying the heat 400 and the heat 402 for the same amount of time as each other, or for different times. For example, the Joule heating which is more direct may be performed for a shorter time than core heating. The specifications regarding the slot liner 200 can define the amount and level of heating that should be performed for curing of the expanded material 300 and the expanded material 302. For example, the specifications can give a temperature range for curing.

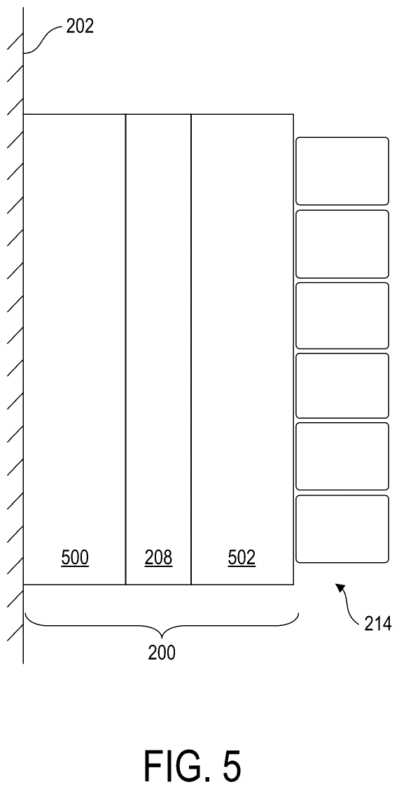

FIG. 5 shows an example where the expanded materials of the slot liner 200 of FIG. 4 have been cured. The slot liner 200 here has a cured material 500 that abuts the surface 202, and a cured material 502 that abuts the winding 214. The base layer 208, by contrast, may be essentially unaffected by the cure heating. As such, the slot liner 200 has been heat treated to perform its insulating, thermal and protective function.

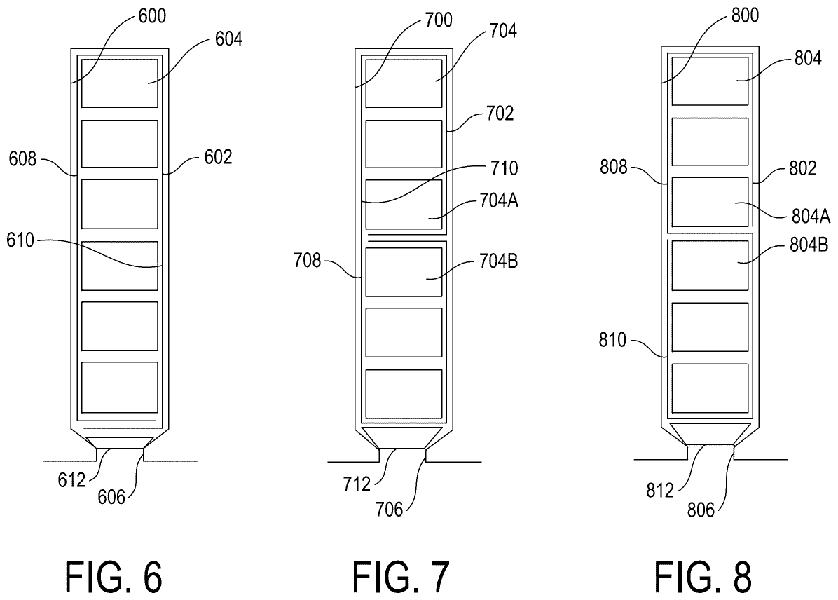

In FIGS. 6-11, examples stator slots are shown without explicitly showing the rest of the stator core for simplicity.

FIG. 6 shows an example of an open slot 600 with a slot liner 602 and windings 604. The windings 604 here include multiple individual windings (e.g., each separately insulated) arranged as a stack in the open slot 600. For example, the windings 604 can be inserted through an opening 606 of the open slot 600—that is, in a radial direction relative to a cylinder axis of the stator—to form the stack that is essentially enclosed by the slot liner 602.

The configuration of the slot liner 602 relative to the stack of the windings 604 can be characterized as an “O” shape. In analogy with the layered structure of the slot liner 112 of FIG. 1, the slot liner 602 can include an expanding material 608 on one side of a base layer, and an expanding material 610 on an opposite side of the base layer. The windings 604 and the slot liner 602 are positioned so that only the expanding material 608, and not the expanding material 610, in part abuts the open slot 600. Also, the windings 604 and the slot liner 602 are positioned so that only the expanding material 610, and not the expanding material 608, in part abuts the windings 604. The slot liner 602 can be wrapped around an entire periphery of the stack, wherein ends of the slot liner 602 overlap each other at an end of the stack adjacent the opening 606. The ends of the slot liner 602 can be folded over (e.g., into the configuration shown) by the act of inserting a wedge 612 axially along the axis of the stator to cover the opening 606. If the wedge 612 has sufficient flexibility, the insertion can be made radially, through the opening 606, instead of axially.

FIG. 7 shows another example of an open slot 700 with a slot liner 702 and windings 704. The windings 704 here include multiple individual windings (e.g., each separately insulated) arranged as a stack in the open slot 700. For example, the windings 704 can be inserted through an opening 706 of the open slot 600—that is, in a radial direction relative to a cylinder axis of the stator—to form the stack that is enclosed by the slot liner 702.

The configuration of the slot liner 702 relative to the stack of the windings 704 can be characterized as a “B” shape. In analogy with the layered structure of the slot liner 112 of FIG. 1, the slot liner 702 can include an expanding material 708 on one side of a base layer, and an expanding material 710 on an opposite side of the base layer. The windings 704 and the slot liner 702 are positioned so that only the expanding material 708, and not the expanding material 710, in part abuts the open slot 700. Also, the windings 704 and the slot liner 702 are positioned so that only the expanding material 710, and not the expanding material 708, in part abuts the windings 704. The slot liner 702 can be wrapped around an entire periphery of the stack, wherein ends of the slot liner 702 overlap each other between two adjacent windings 704A and 704B of the windings 704. A wedge 712 can be inserted radially along the axis of the stator to cover the opening 706.

FIG. 8 shows another example of an open slot 800 with a slot liner 802 and windings 804. The windings 804 here include multiple individual windings (e.g., each separately insulated) arranged as a stack in the open slot 800. For example, the windings 804 can be inserted through an opening 806 of the open slot 800—that is, in a radial direction relative to a cylinder axis of the stator—to form the stack that is enclosed by the slot liner 802.

The configuration of the slot liner 802 relative to the stack of the windings 804 can be characterized as an “S” shape. In analogy with the layered structure of the slot liner 112 of FIG. 1, the slot liner 802 can include an expanding material 808 on one side of a base layer, and an expanding material 810 on an opposite side of the base layer. The windings 804 and the slot liner 802 are positioned so that each of the expanding material 808 and the expanding material 810 in part abuts the open slot 800, and so that each of the expanding material 808 and the expanding material 810 in part abuts the windings 804. The slot liner 802 can be positioned between two adjacent windings 804A and 804B of the windings 804 and a remainder of the slot liner 802 can be wrapped around an entire periphery of the stack of the windings 804. A wedge 812 can be inserted radially along the axis of the stator to cover the opening 806.

In some implementations, the slot liner 702 and/or the slot liner 802 can be used to provide additional insulation between adjacent windings within a slot. For example, this can be done when the windings of a slot are dedicated to different phases of the motor current.

In the stators of FIGS. 7 and 8, the windings and the slot liners are axially inserted into the respective stator cores (that is, the insertion is not done in a radial direction through the slot openings). In such implementations, the openings and wedges can still be included based on design requirements.

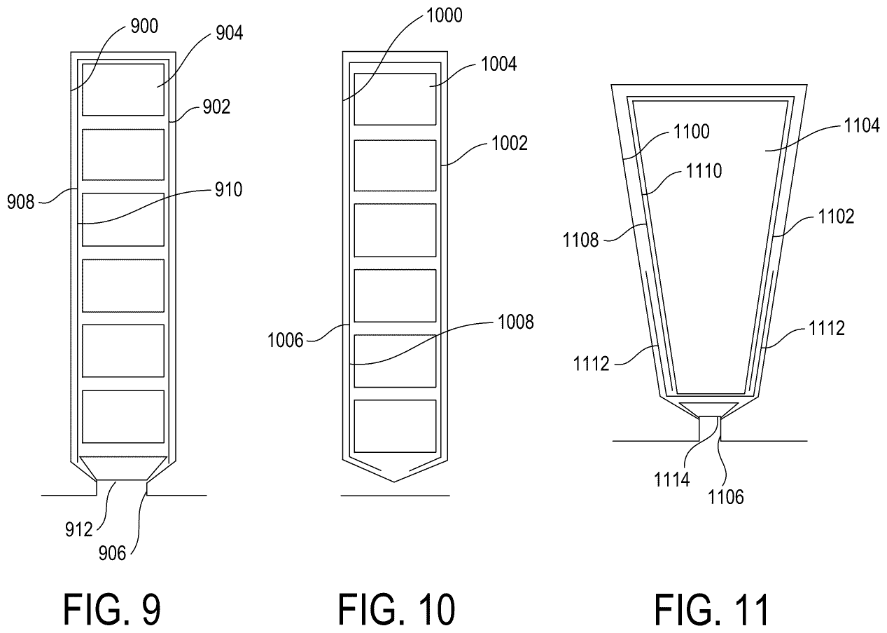

FIG. 9 shows another example of an open slot 900 with a slot liner 902 and windings 904. The windings 904 here include multiple individual windings (e.g., each separately insulated) arranged as a stack in the open slot 900. For example, the windings 904 can be inserted through an opening 906 of the open slot 900—that is, in a radial direction relative to a cylinder axis of the stator—to form the stack that is partially enclosed by the slot liner 902.

The configuration of the slot liner 902 relative to the stack of the windings 904 can be characterized as a “U” shape. In analogy with the layered structure of the slot liner 112 of FIG. 1, the slot liner 902 can include an expanding material 908 on one side of a base layer, and an expanding material 910 on an opposite side of the base layer. The windings 904 and the slot liner 902 are positioned so that only the expanding material 908, and not the expanding material 910, in part abuts the open slot 900. Also, the windings 904 and the slot liner 902 are positioned so that only the expanding material 910, and not the expanding material 908, in part abuts the windings 904. The slot liner 602 can be wrapped around substantially an entire periphery of the stack without ends of the slot liner 902 overlapping each other. A wedge 912 can be inserted radially along the axis of the stator to cover the opening 906.

FIG. 10 shows another example of a closed slot 1000 with a slot liner 1002 and windings 1004. The windings 1004 here include multiple individual windings (e.g., each separately insulated) arranged as a stack in the closed slot 1000. For example, the windings 1004 can be inserted in an axial direction relative to a cylinder axis of the stator to form the stack that is substantially enclosed by the slot liner 1002.

The configuration of the slot liner 1002 relative to the stack of the windings 1004 can be characterized as an “O” or a “U” shape. In analogy with the layered structure of the slot liner 112 of FIG. 1, the slot liner 1002 can include an expanding material 1006 on one side of a base layer, and an expanding material 1008 on an opposite side of the base layer. The windings 1004 and the slot liner 1002 are positioned so that only the expanding material 1006, and not the expanding material 1008, in part abuts the closed slot 1000. Also, the windings 1004 and the slot liner 1002 are positioned so that only the expanding material 1008, and not the expanding material 1006, in part abuts the windings 1004. The slot liner 1002 can be wrapped around substantially an entire periphery of the stack, without ends of the slot liner 1002 overlapping each other.

FIG. 11 shows another example of an open slot 1100 with a slot liner 1102 and a winding 1104. The winding 1104 here includes a single winding. For example, the winding 1104 can have a trapezoid shape. The open slot 1100 can have an opening 1106. In analogy with the layered structure of the slot liner 112 of FIG. 1, the slot liner 1102 can include an expanding material 1108 on one side of a base layer, and an expanding material 1110 on an opposite side of the base layer. The winding 1104 and the slot liner 1102 are positioned so that only the expanding material 1108, and not the expanding material 1110, in part abuts the open slot 1100. Also, the winding 1104 and the slot liner 1102 are positioned so that only the expanding material 1110, and not the expanding material 1108, in part abuts the winding 1104. The slot liner 1102 can be wrapped around substantially an entire periphery of the winding 1104 without ends of the slot liner 1102 overlapping each other. A slot liner 1112 can also be placed inside the open slot 1100 to cover a portion of the periphery of the winding 1104 that is not covered by the slot liner 1102. For example, the slot liner 1112 can be a multi-layer expanding slot liner. A wedge 1114 can be inserted radially along the axis of the stator to cover the opening 1106.

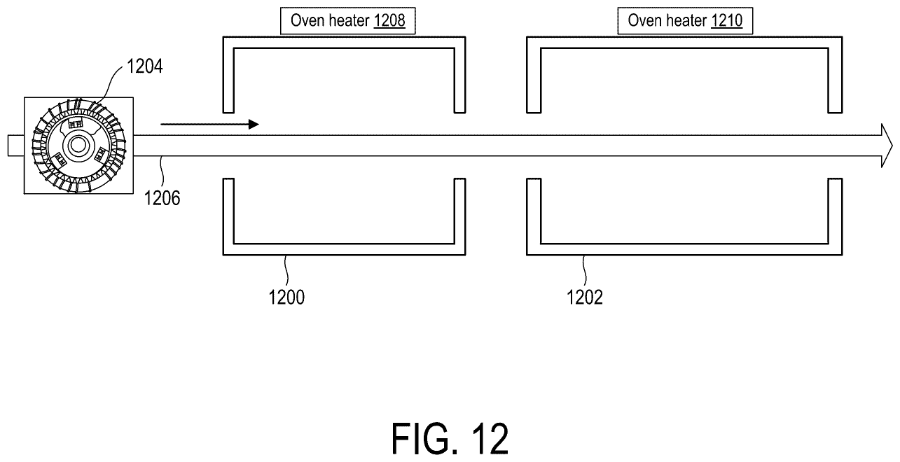

FIG. 12 schematically shows an example of performing expansion using an expansion oven 1200 and performing curing using a cure oven 1202. The expansion oven 1200 and/or the cure oven 1202 can be used with one or more other examples described elsewhere herein. Here, a stator 1204 is to be subjected to heat treatment for expansion and curing of a multi-layer expanding slot liner. The heat treatment is here schematically illustrated as a process 1206 in which the stator 1204 enters into the expansion oven 1200 and the cure oven 1202 in order. In some implementations, the process 1206 can partially or entirely replace the use of the induction heater 122 of FIG. 1. That is, at least one oven can be used for heating the core of the 1204, in combination with heating by the winding, to perform expansion and curing.

The expansion oven 1200 can include an oven heater 1208 to control the temperature of, and/or length of heat treatment by, the expansion oven 1200. When the heat treatment by the expansion oven 1200 is complete, expanding materials of the multi-layer expanding slot liner have been expanded according to specification.

The cure oven 1202 can include an oven heater 1210 to control the temperature of, and/or length of heat treatment by, the cure oven 1202. When the heat treatment by the cure oven 1202 is complete, expanded materials of the multi-layer expanding slot liner have been cured according to specification.

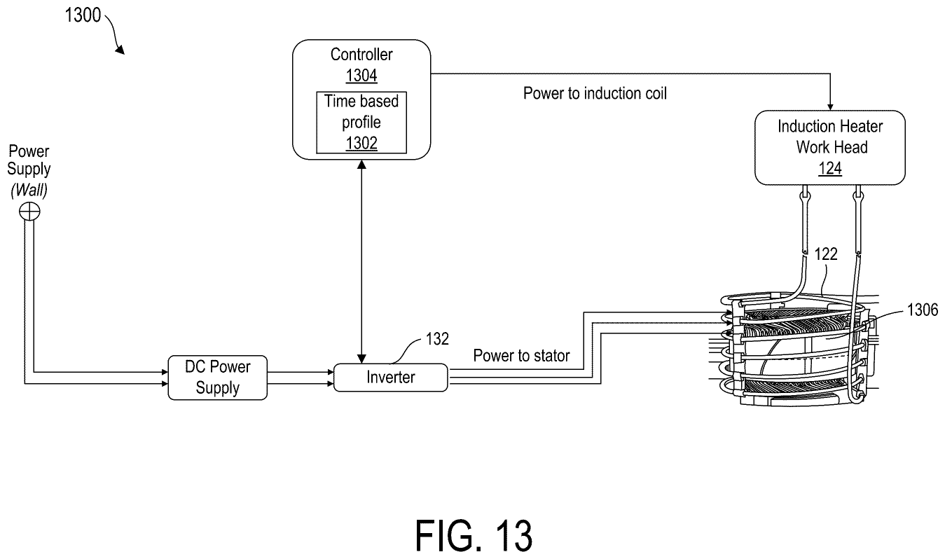

FIG. 13 shows an example of a system 1300 that can be used for performing heat treatment for a stator as defined by a time based profile 1302 when installing a multi-layer expanding slot liner in a stator. The system 1300 and/or the time based profile 1302 can be used with one or more other examples described elsewhere herein. Some components that are similar or identical to corresponding components of FIG. 1 will not be described in detail.

The system 1300 includes a controller 1304 that is connected to the induction heater work head 124 and the inverter 132 for performing a heating process on a stator 1306 according to the time based profile 1302. For example, the controller 1304 can cause the induction heater 122 to heat the stator core, and can cause the inverter 132 to heat stator windings by Joule heating, to effectuate expansion and curing of the multi-layer expanding slot liner in the 1306. In some implementations, the system 1300 can use one or both of the expansion oven 1200 or the cure oven 1202 of FIG. 1 instead of, or in addition to, the induction heater 122.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one”.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A method comprising:
placing a slot liner and a winding inside a slot of a stator core, the slot liner including i) a base layer of a dielectric material, and ii) an expanding material that comprises a first expanding material on a first side of the base layer and a second expanding material on a second side of the base layer opposite the first side;
expanding the expanding material by applying first heat to the expanding material through the stator core, and by applying second heat to the expanding material through the winding; and
curing the expanding material by applying third heat to the expanding material through the stator core, and by applying fourth heat to the expanding material through the winding.

2. The method of claim 1, wherein at least one of applying the first heat or applying the third heat comprises using an induction heater to induce heat in the stator core.

3. The method of claim 1, wherein at least one of applying the first heat or applying the third heat comprises using at least one oven for heating the stator core.

4. The method of claim 3, wherein heating the stator core comprises using a first oven for expanding the expanding material and using a second oven for curing the expanding material.

5. The method of claim 1, wherein at least one of applying the second heat or applying the fourth heat comprises performing Joule heating of the winding.

6. The method of claim 1, wherein the method comprises placing the slot liner and a plurality of windings inside the slot, the plurality of windings including the winding, the plurality of windings forming a stack inside the slot.

7. The method of claim 6, wherein placing the slot liner and the plurality of windings inside the slot comprises causing only the first expanding material, and not the second expanding material, in part to abut the slot, and comprises causing only the second expanding material, and not the first expanding material, in part to abut the plurality of windings.

8. The method of claim 7, wherein placing the slot liner and the plurality of windings inside the slot comprises wrapping the slot liner around an entire periphery of the stack, and wherein ends of the slot liner overlap each other at one end of the stack.

9. The method of claim 8, wherein the slot is an open slot having an opening, the method further comprising, after placing the slot liner and the plurality of windings inside the slot, covering the opening using a wedge.

10. The method of claim 7, wherein placing the slot liner and the plurality of windings inside the slot comprises wrapping the slot liner around an entire periphery of the stack, and wherein ends of the slot liner overlap each other between two adjacent windings of the plurality of windings.

11. The method of claim 10, wherein the slot is an open slot having an opening, the method further comprising, after placing the slot liner and the plurality of windings inside the slot, covering the opening using a wedge.

12. The method of claim 7, wherein placing the slot liner and the plurality of windings inside the slot comprises wrapping the slot liner around substantially an entire periphery of the stack without ends of the slot liner overlapping each other.

13. The method of claim 12, wherein the slot is an open slot having an opening, the method further comprising, after placing the slot liner and the plurality of windings inside the slot, covering the opening using a wedge.

14. The method of claim 12, wherein the slot is a closed slot.

15. The method of claim 6, wherein placing the slot liner and the plurality of windings inside the slot comprises causing each of the first expanding material and the second expanding material in part to abut the slot, and comprises causing each of the first expanding material and the second expanding material in part to abut the plurality of windings.

16. The method of claim 15, wherein placing the slot liner inside the slot comprises positioning the slot liner between two adjacent windings of the plurality of windings, and wrapping a remainder of the slot liner around an entire periphery of the stack.

17. The method of claim 16, wherein the slot is an open slot having an opening, the method further comprising, after placing the slot liner and the plurality of windings inside the slot, covering the opening using a wedge.

18. The method of claim 1, wherein the winding is a single winding of the slot.

19. The method of claim 18, wherein the slot is an open slot having an opening, wherein the slot liner is a first slot liner, wherein only the first expanding material of the first slot liner, and not the second expanding material of the first slot liner, in part abuts the slot, and wherein only the second expanding material of the first slot liner, and not the first expanding material of the first slot liner, in part abuts the winding, the method further comprising placing also a second slot liner inside the slot to cover a portion of a periphery of the winding not covered by the first slot liner.

20. The method of claim 19, wherein the periphery of the winding has a trapezoid shape.

21. A system comprising:
a controller configured for performing a heating process for a stator as defined by a time based profile, the stator including a stator core having a slot, a slot liner and a winding to be placed inside the slot, the slot liner including i) a base layer of a dielectric material, and ii) an expanding material that comprises a first expanding material on a first side of the base layer and a second expanding material on a second side of the base layer opposite the first side;
a first heater operated by the controller, the first heater to apply first heat to the expanding material through the stator core to expand the expanding material, and to apply third heat to the expanding material through the stator core to cure the expanding material; and
a second heater operated by the controller, the second heater to apply second heat to the expanding material through the winding to cure the expanding material, and configured to apply fourth heat to the expanding material through the winding to cure the expanding material.

22. The system of claim 21, wherein the first heater comprises an induction heater including a coil, wherein the stator core is placed inside the coil for the induction heater to apply the first heat and the third heat.

23. The system of claim 21, wherein the second heater comprises one or more ovens, wherein the stator core is placed inside the one or more ovens for the second heater to apply the first heat and the third heat.

24. The system of claim 23, wherein the second heater comprises at least a first oven and a second oven, wherein the stator core is placed inside the first oven for the second heater to apply the first heat and wherein the stator core is placed inside the second oven for the second heater to apply the third heat.
